(19) United States
(12) Patent Application Publication
(10) Pub. No.: US 2025/0319687 A1
(43) Pub. Date: Oct. 16, 2025

(54) ALUMINUM PLASTIC FILM AND METHOD FOR PRODUCING THE SAME

(71) Applicant: NAN YA PLASTICS CORPORATION, TAIPEI (TW)

(72) Inventors: CHING-YAO YUAN, TAIPEI (TW); TENG-KO MA, TAIPEI (TW); CHAO-HSIEN LIN, TAIPEI (TW); Chih-Feng Wang, TAIPEI (TW)

(21) Appl. No.: 18/733,982

(22) Filed: Jun. 5, 2024

(30) Foreign Application Priority Data
Apr. 16, 2024 (TW) 113114044

(51) Int. Cl. B32B 15/09; B32B 7/12; B32B 15/088; B32B 15/20; B32B 37/12; B32B 38/00; B32B 38/04

(52) U.S. Cl. CPC B32B 15/09; B32B 7/12; B32B 15/088; B32B 15/20; B32B 37/1284; B32B 38/0036; B32B 38/04; B32B 2038/042; B32B 2250/03; B32B 2250/40; B32B 2307/7376; B32B 2309/025; B32B 2311/24; B32B 2367/00; B32B 2377/00

(57) ABSTRACT

An aluminum plastic film and method for producing the same are provided. The method includes a preparing process implemented by providing an aluminum foil metal film having a first surface and a second layer; a polyurethane glue coating process implemented by coating a polyurethane glue onto the first surface of the aluminum foil metal film; an outer-layer polymer film pasting process implemented by pasting an outer-layer polymer film onto the first surface through the polyurethane glue; a polyolefin glue coating process implemented by coating a polyolefin glue onto the second surface of the aluminum foil metal film; and an inner-layer polymer film pasting process implemented by pasting an inner-layer polymer film onto the second surface through the polyolefin glue to form an aluminum plastic film. A ratio between a thickness of the inner-layer polymer film and a thickness of the outer-layer polymer film is between 1.6 and 5.5.

### CROSS-REFERENCE TO RELATED PATENT APPLICATION

This application claims the benefit of priority to Taiwan Patent Application No. 113114044, filed on Apr. 16, 2024. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to an aluminum plastic film and method for producing the same, and more particularly to an aluminum plastic film applicable to a deep punching depth and method for producing the same.

### BACKGROUND OF THE DISCLOSURE

After a conventional aluminum plastic film is punched with a deep punching depth, the conventional aluminum plastic film can easily exhibit warpage or holes formed by breakage. More specifically, when the conventional aluminum plastic film is applied to a battery product having a deep punching depth, any holes formed by breakage in the conventional aluminum plastic film can easily cause leakage of battery fluid, and warpage of the conventional aluminum plastic film can seriously affect the production efficiency of the battery product.

### SUMMARY OF THE DISCLOSURE

In response to the above-referenced technical inadequacies, the present disclosure provides an aluminum plastic film and method for producing the same, so as to effectively improve on the conventional aluminum plastic film that can easily exhibit warpage or holes from breakage after being applied to a battery product having a deep punching depth.

In order to solve the above-mentioned problems, one of the technical aspects adopted by the present disclosure is to provide a method for producing an aluminum plastic film. The method includes a preparing process, a polyurethane glue coating process, an outer-layer polymer film pasting process, a polyolefin glue coating process, and an inner-layer polymer film pasting process. The preparing process is implemented by providing an aluminum foil metal film having a first surface and a second surface opposite to each other. The polyurethane glue coating process is implemented by coating a polyurethane glue onto the first surface of the aluminum foil metal film. The outer-layer polymer film pasting process is implemented by pasting an outer-layer polymer film onto the first surface through the polyurethane glue. The outer-layer polymer film is at least one of a nylon polymer film, a polyester polymer film, and a multilayer nylon/polyester polymer film. The polyolefin glue coating process is implemented by coating a polyolefin glue onto the second surface of the aluminum foil metal film. The inner-layer polymer film pasting process is implemented by pasting an inner-layer polymer film onto the second surface through the polyolefin glue to form an aluminum plastic film. The inner-layer polymer film is a polyolefin polymer film. A ratio between a thickness of the inner-layer polymer film and a thickness of the outer-layer polymer film is between 1.6 and 5.5.

In one of the possible or preferred embodiments, before the outer-layer polymer film pasting process, the method further includes a preheating process implemented by preheating the outer-layer polymer film at a temperature between 140° C. and 180° C. for 10 seconds to 30 seconds. The thickness of the outer-layer polymer film is between 20 μm to 25 μm.

In one of the possible or preferred embodiments, after the preheating process, a machine direction shrinkage rate of the outer-layer polymer film is less than or equal to 1%, and a transverse direction shrinkage rate of the outer-layer polymer film is less than or equal to 1%.

In one of the possible or preferred embodiments, the thickness of the outer-layer polymer film is between 10 μm and 20 μm.

In one of the possible or preferred embodiments, after the outer-layer polymer film pasting process, the method further includes a polyurethane glue aging process implemented by setting the aluminum foil metal film pasted with the outer-layer polymer film in an environment having a temperature between 45° C. and 65° C. for 84 hours to 108 hours.

In one of the possible or preferred embodiments, the polyurethane glue aging process is divided into a first polyurethane glue aging stage, a second polyurethane glue aging stage, and a third polyurethane glue aging stage. A setting time period in the third polyurethane glue aging stage is greater than a setting time period in the first polyurethane glue aging stage and a setting time period in the second polyurethane glue aging stage. A setting temperature in the third polyurethane glue aging stage is greater than a setting temperature in the second polyurethane glue aging stage, and the setting temperature in the second polyurethane glue aging stage is greater than a setting temperature in the first polyurethane glue aging stage.

In one of the possible or preferred embodiments, after the inner-layer polymer film pasting process, the method further includes a polyolefin glue aging process implemented by setting the aluminum foil metal film pasted with the inner-layer polymer film in an environment having a temperature between 40° C. and 55° C. for 84 hours to 108 hours.

In one of the possible or preferred embodiments, the polyolefin glue aging process is divided into a first polyolefin glue aging stage and a second polyolefin glue aging stage. A setting temperature in the second polyolefin glue aging stage is greater than a setting temperature in the first polyolefin glue aging stage, and a setting time period in the second polyolefin glue aging is greater than or equal to a setting time period in the first polyolefin glue aging stage.

In one of the possible or preferred embodiments, after being punched with a punching depth of 5 mm, an appearance of the aluminum plastic film does not exhibit apparent warpage or holes formed by breakage.

Therefore, in the aluminum plastic film and method for producing the same provided by the present disclosure, by virtue of “the ratio between the thickness of the inner-layer polymer film and the thickness of the outer-layer polymer film being between 1.6 and 5.5,” the issue with the conventional aluminum plastic film easily exhibiting warpage or holes from breakage after being applied to a battery product having a deep punching depth can be effectively improved.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a schematic view of an aluminum plastic film of the present disclosure;

FIG. 2 is a flowchart of a method for producing an aluminum plastic film according to a first embodiment of the present disclosure;

FIG. 3 is a flowchart of a method for producing an aluminum plastic film according to a second embodiment of the present disclosure; and

FIG. 4 is a flowchart of a method for producing an aluminum plastic film according to a third embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

### First Embodiment

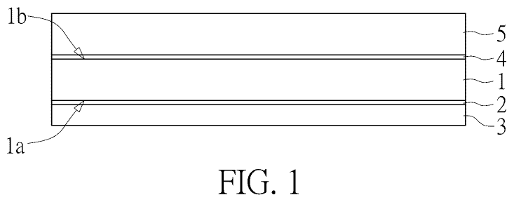

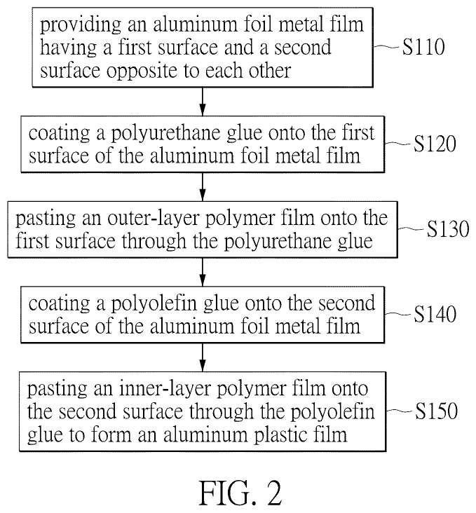

Referring to FIG. 1 and FIG. 2, FIG. 1 is a schematic view of an aluminum plastic film of the present disclosure, and FIG. 2 is a flowchart of a method for producing an aluminum plastic film according to a first embodiment of the present disclosure. The first embodiment of the present disclosure provides a method for producing an aluminum plastic film. The method includes a preparing process S110, a polyurethane glue coating process S120, an outer-layer polymer film pasting process S130, a polyolefin glue coating process S140, and an inner-layer polymer pasting process S150.

In the preparing process S110, an aluminum foil metal film 1 is provided, and the aluminum foil metal film 1 has a first surface 1a and a second surface 1b opposite to each other. The aluminum foil metal film 1 can be a composite structure, but the present disclosure does not limit the specific structure of the aluminum foil metal film 1. For example, the aluminum foil metal film 1 can include an aluminum foil (not shown) and two anti-corrosion treatment layers (not shown) arranged at two opposite sides of the aluminum foil. The two anti-corrosion treatment layers can be used to prevent corrosion of the aluminum foil. The material type of the two anti-corrosion treatment layers can be, for example, an inorganic coating or an organic-inorganic composite coating, but the present disclosure is not limited thereto. For example, each of the two anti-corrosion treatment layers can be a phosphate treatment layer.

In the polyurethane glue coating process S120, a polyurethane glue 2 is coated onto the first surface 1a of the aluminum plastic metal foil 1. The polyurethane glue 2 can be formed by reacting a polyol material and an isocyanate material, but the present disclosure does not limit the specific material of the polyurethane glue 2. The polyol material can have a weight-average molecular weight (Mw) of between 25,000 and 75,000, a number-average molecular weight (Mn) of between 18,000 and 55,000, and a glass transition temperature (Tg) of between −30° C. and 60° C. The isocyanate material can include a first isocyanate component. The first isocyanate component is an adduct formed by adding toluene diisocyanate (TDI) to a polyol having a functionality of between 2 and 4, and the polyol has a carbon chain length of between C4 and C15. The isocyanate material can further include a second isocyanate component, and the second isocyanate component is an adduct formed by adding isocyanate to a polyol having a long carbon chain and a functionality of between 2 and 4.

In the outer-layer polymer film pasting process S130, an outer-layer polymer film 3 is pasted onto the first surface 1a through the polyurethane glue 2. The outer-layer polymer film 3 is at least one of a nylon polymer film, a polyester polymer film, and a multilayer nylon/polyester polymer film. In addition, the outer-layer polymer film 3 can be, for example, at least one of a nylon/polyester co-extruded polymer film and a blown film.

In the polyolefin glue coating process S140, a polyolefin glue 4 is coated onto the second surface 1b of the aluminum foil metal film 1. The components of the polyolefin glue can include a modified polyolefin polymer and a hardener. An added amount of the hardener ranges from 1 phr to 10 phr relative to 100 phr of the modified polyolefin polymer. Types of the hardener can be selected according to requirements. For example, the hardener can be a polyisocyanate hardener (e.g., DESMODUR® ultra N 3300), but the present disclosure is not limited thereto.

The modified polyolefin polymer is a propylene random copolymer formed by co-polymerization of a propylene monomer and other monomers. Based on a total weight of the propylene random copolymer being 100 wt %, a proportion of the propylene monomer is greater than 50 wt %. The propylene random copolymer can be polymerized from an ethylene monomer, the propylene monomer, and a butylene monomer, but the present disclosure is not limited thereto.

The modified polyolefin polymer has a modified group, and the modified group can be grafted onto a main chain or a branch of the modified polyolefin polymer. In one exemplary embodiment, the modified group is formed from maleic anhydride or a maleic anhydride derivative (a compound in which its structure contains the maleic anhydride). Therefore, a structure of the modified group contains the maleic anhydride. Specifically, through grafting, the modified group can be formed from the maleic anhydride, methyltetrahydrophthalic anhydride, transposition tetrahydrophthalic anhydride, tetrahydrophthalic anhydride, methylhexahydrophthalic anhydride, methylnadic anhydride, or 2,3-naphthalic anhydride.

In the inner-layer polymer film pasting process S150, an inner-layer polymer film 5 is pasted onto the second surface 1b through the polyolefin glue 4 to form an aluminum plastic film 100.

The inner-layer polymer film 5 is a polyolefin polymer film, and the polyolefin polymer film can be, for example, a cast polypropylene (CPP) film. It is worth mentioning that, since the inner-layer polymer film 5 (e.g., the above-mentioned cast polypropylene film) is usually not stretched, a stress in the outer-layer polymer film 3 is greater than a stress in the inner-layer polymer film 5. If no proper processing is not provided, the aluminum plastic film 100 may easily exhibit apparent warpage or holes formed by breakage.

Accordingly, in the present embodiment, a thickness of the inner-layer polymer film 5 is greater than a thickness of the outer-layer polymer film 3, and a ratio between the thickness of the inner-layer polymer film 5 and the thickness of the outer-layer polymer film 3 is between 1.6 and 5.5. Preferably, the ratio between the thickness of the inner-layer polymer film 5 and the thickness of the outer-layer polymer film 3 is between 1.6 and 2.75 or between 2 and 5.5. In this way, the stress in the inner-layer polymer film 5 is relatively balanced with the stress in the outer-layer polymer film 3, and the aluminum plastic film 100 do not easily exhibit apparent warpage or holes formed by breakage.

The thickness of the inner-layer polymer film 5 can be between 40 μm and 55 μm, and the thickness of the outer-layer polymer film 3 can be between 10 μm and 25 μm. Preferably, the thickness of the outer-layer polymer film 3 can be between 10 μm and 20 μm, so as to further lower the stress in the outer-layer polymer film 3. In addition, after being punched with a punching depth of 5 mm, an appearance of the aluminum plastic film 100 does not exhibit apparent warpage or holes formed by breakage.

### Second Embodiment

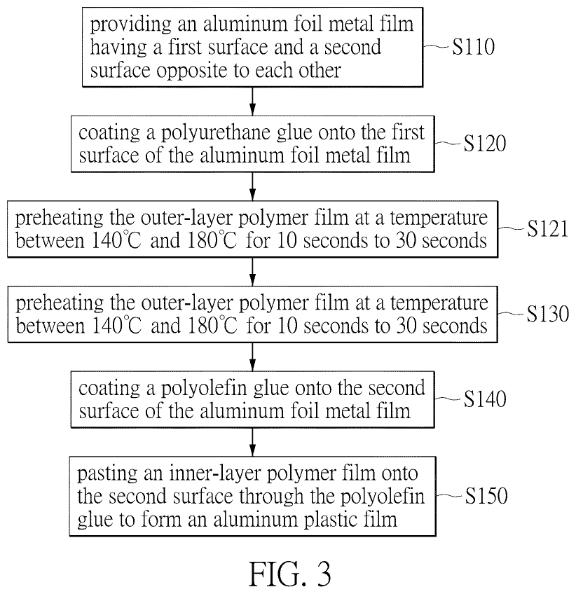

Referring to FIG. 3, FIG. 3 is a flowchart of a method for producing an aluminum plastic film according to a second embodiment of the present disclosure. A second embodiment of the present disclosure is similar to the above-mentioned first embodiment, and the difference between the second embodiment and the first embodiment is that, in the second embodiment of the present disclosure, the method further includes a preheating process $121 implemented by preheating the outer-layer polymer film 3 at a temperature between 140° C. and 180° C. for 10 seconds to 30 seconds. Preferably, in the preheating process S121, the outer-layer polymer film 3 is preheated at about 160° C. for about 20 seconds. Through the preheating process S121, the stress in the outer-layer polymer film 3 can be lowered in advance. In this way, the thickness of the outer-layer polymer film 3 is not required to be decreased. For example, in the present embodiment, the thickness of the outer-layer polymer film 3 can be between 20 μm to 25 μm.

In addition, after the preheating process S121, a machine direction shrinkage rate of the outer-layer polymer film 3 is less than or equal to 1%, and a transverse direction shrinkage rate of the outer-layer polymer film 3 is less than or equal to 1%. In other words, if the temperature in the preheating process S121 is too low or the time period of the preheating process S121 is too short, the machine direction shrinkage rate or the transverse direction shrinkage rate of the outer-layer polymer film 3 may be too high (e.g., greater than 1%), and accordingly, the stress in the outer-layer polymer film 3 cannot be effectively lowered.

### Third Embodiment

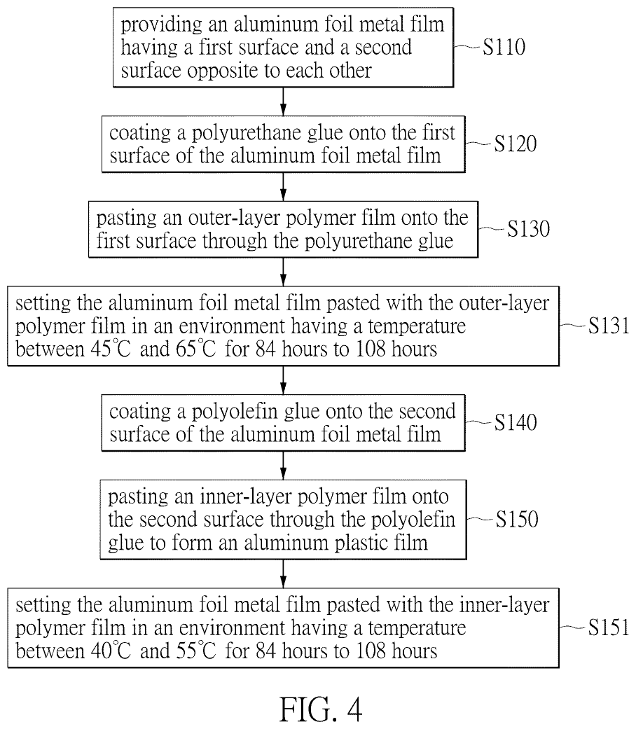

Referring to FIG. 4, FIG. 4 is a flowchart of a method for producing an aluminum plastic film according to a third embodiment of the present disclosure. A third embodiment of the present disclosure is similar to the above-mentioned first embodiment, and the difference between the third embodiment and the first embodiment is that, after the outer-layer polymer film pasting process S130, the method can further include a polyurethane glue aging process S131 implemented by setting the aluminum foil metal film 1 pasted with the outer-layer polymer film 3 in an environment having a temperature between 45° C. and 65° C. for 84 hours to 108 hours.

A setting temperature in the polyurethane glue aging process S131 can be gradiently increased. Specifically, the polyurethane glue aging process S131 can be divided into a first polyurethane glue aging stage, a second polyurethane glue aging stage, and a third polyurethane glue aging stage. A setting time period in the third polyurethane glue aging stage is greater than a setting time period in the first polyurethane glue aging stage and a setting time period in the second polyurethane glue aging stage. A setting temperature in the third polyurethane glue aging stage is greater than a setting temperature in the second polyurethane glue aging stage, and the setting temperature in the second polyurethane glue aging stage is greater than a setting temperature in the first polyurethane glue aging stage.

Preferably, the setting temperature and the setting time period in the first polyurethane glue aging stage can be respectively between 45° C. and 55° C. and 18 hours and 30 hours, the setting temperature and the setting time period in the second polyurethane glue aging stage can be respectively between 50° C. and 60° C. and 18 hours and 30 hours, and the setting temperature and the setting time period in the third polyurethane glue aging stage can be respectively between 55° C. and 65° C. and 42 hours and 54 hours. More preferably, the setting temperature and the setting time period in the first polyurethane glue aging stage can be respectively about 50° C. and about 24 hours, the setting temperature and the setting time period in the second polyurethane glue aging stage can be respectively about 55° C. and about 24 hours, and the setting temperature and the setting time period in the third polyurethane glue aging stage can be respectively about 60° C. and about 48 hours.

In addition, after the inner-layer polymer film pasting process S150, the method can further include a polyolefin glue aging process S151 implemented by setting the aluminum foil metal film 1 pasted with the inner-layer polymer film 5 in an environment having a temperature between 40° C. and 55° C. for 84 hours to 108 hours.

A setting temperature in the polyolefin glue aging process S151 can be gradiently increased. Specifically, the polyolefin glue aging process S151 can be divided into a first polyolefin glue aging stage and a second polyolefin glue aging stage. A setting temperature in the second polyolefin glue aging stage is greater than a setting temperature in the first polyolefin glue aging stage, and a setting time period in the second polyolefin glue aging is greater than or equal to a setting time period in the first polyolefin glue aging stage.

Preferably, the setting temperature and the setting time period in the first polyolefin glue aging stage can be respectively between 40° C. and 50° C. and between 42 hours and 54 hours, and the setting temperature and the setting time period in the second polyolefin glue aging stage can be respectively between 45° C. and 55° C. and between 42 hours and 54 hours. More preferably, the setting temperature and the setting time period in the first polyolefin glue aging stage can be respectively about 45° C. and about 48 hours, and the setting temperature and the setting time period in the second polyolefin glue aging stage can be respectively about 50° C. and about 48 hours.

It is worth mentioning that, the polyurethane glue aging process S131 and the polyolefin glue aging process S151 in the present embodiment can be in cooperation with the preheating process S121 in the second embodiment, but the present disclosure is not limited thereto. The present disclosure also provides an aluminum plastic film 100, and the aluminum plastic film 100 can be produced by the method mentioned in any one of the above-mentioned embodiments.

### [Experimental Results]

Hereinafter, a more detailed description will be provided with reference to Exemplary Examples 1 to 5 and Comparative Examples 1 to 2. However, the Exemplary Examples below are only used to aid in understanding of the present disclosure, and are not to be construed as limiting the scope of the present disclosure.

Exemplary Example 1: in the aluminum plastic film, the material of the inner-layer polymer film is polyolefin, the thickness of the inner-layer polymer film is 45 μm, the polyolefin glue is set at 45° C. for 48 hours and then set at 50° C. for 48 hours as the aging condition, the polyurethane glue is set at 50° C. for 24 hours and 55° C. for 24 hours and then set at 60° C. for 48 hours as the aging condition, the outer-layer polymer film is not preheated, the material of the outer-layer polymer film is nylon, and the thickness of the outer-layer polymer film is 20 μm.

Exemplary Example 2: in the aluminum plastic film, the material of the inner-layer polymer film is polyolefin, the thickness of the inner-layer polymer film is 50 μm, the polyolefin glue is set at 45° C. for 48 hours and then set at 50° C. for 48 hours as the aging condition, the polyurethane glue is set at 50° C. for 24 hours and 55° C. for 24 hours and then set at 60° C. for 48 hours as the aging condition, the outer-layer polymer film is not preheated, the material of the outer-layer polymer film is nylon, and the thickness of the outer-layer polymer film is 15 μm.

Exemplary Example 3: in the aluminum plastic film, the material of the inner-layer polymer film is polyolefin, the thickness of the inner-layer polymer film is 40 μm, the polyolefin glue is set at 45° C. for 48 hours and then set at 50° C. for 48 hours as the aging condition, the polyurethane glue is set at 50° C. for 24 hours and 55° C. for 24 hours and then set at 60° C. for 48 hours as the aging condition, the outer-layer polymer film is preheated at 160° C. for 20 seconds, the material of the outer-layer polymer film is nylon, and the thickness of the outer-layer polymer film is 25 μm.

Exemplary Example 4: in the aluminum plastic film, the material of the inner-layer polymer film is polyolefin, the thickness of the inner-layer polymer film is 50 μm, the polyolefin glue is set at 45° C. for 48 hours and then set at 50° C. for 48 hours as the aging condition, the polyurethane glue is set at 50° C. for 24 hours and 55° C. for 24 hours and then set at 60° C. for 48 hours as the aging condition, the outer-layer polymer film is not preheated, the material of the outer-layer polymer film is nylon/PET, and the thickness of the outer-layer polymer film is 15 μm.

Exemplary Example 5: in the aluminum plastic film, the material of the inner-layer polymer film is polyolefin, the thickness of the inner-layer polymer film is 40 μm, the polyolefin glue is set at 45° C. for 48 hours and then set at 50° C. for 48 hours as the aging condition, the polyurethane glue is set at 50° C. for 24 hours and 55° C. for 24 hours and then set at 60° C. for 48 hours as the aging condition, the outer-layer polymer film is preheated at 160° C. for 20 seconds, the material of the outer-layer polymer film is nylon, and the thickness of the outer-layer polymer film is 25 μm.

Comparative Example 1: in the aluminum plastic film, the material of the inner-layer polymer film is polyolefin, the thickness of the inner-layer polymer film is 40 μm, the polyolefin glue is set at 60° C. for 96 hours as the aging condition, the polyurethane glue is set at 60° C. for 96 hours, the outer-layer polymer film is not preheated, the material of the outer-layer polymer film is nylon, and the thickness of the outer-layer polymer film is 25 μm.

Comparative Example 2: in the aluminum plastic film, the material of the inner-layer polymer film is polyolefin, the thickness of the inner-layer polymer film is 50 μm, the polyolefin glue is set at 60° C. for 96 hours as the aging condition, the polyurethane glue is set at 60° C. for 96 hours, the outer-layer polymer film is not preheated, the material of the outer-layer polymer film is nylon, and the thickness of the outer-layer polymer film is 15 μm.

For the method for producing the aluminum plastic film of each of Exemplary Examples 1 to 5 and Comparative Examples 1 to 2, the parameters and the appearance test result thereof are listed in Table 1 below, and relevant testing methods are described as follows.

The appearance test is carried out by using a mold having a length of 98 mm and a width of 57 mm to punch the aluminum plastic film with a punching depth of 5 mm. “O” represents that the appearance of the aluminum plastic film is flat and has no warpage or holes formed by breakage after being punched. “A” represents that the appearance of the aluminum plastic film is flat but has slight warpage (i.e., a warpage angle of less than or equal to 30 degrees) and no holes formed by breakage. “X” represents that the appearance of the aluminum plastic film exhibits apparent warpage (i.e., a warpage angle of greater than 30 degrees), or the appearance of the aluminum plastic film is flat but has holes formed by breakage.

TABLE 1
[Parameters and Appearance Test Results of Methods for Producing the
Aluminum Plastic Film of Exemplary Examples and Comparative Examples]

| | Exemplary | Exemplary | Exemplary | Exemplary | Exemplary | Comparative | Comparative |
|---|---|---|---|---|---|---|---|
| Item | example 1 | example 2 | example 3 | example 4 | example 5 | example 1 | example 2 |
| Material | Polyolefin | Polyolefin | Polyolefin | Polyolefin | Polyolefin | Polyolefin | Polyolefin |
| of inner- | | | | | | | |
| layer | | | | | | | |
| polymer | | | | | | | |
| film | | | | | | | |
| Thickness | 45 | 50 | 40 | 50 | 40 | 40 | 50 |
| of | | | | | | | |
| inner- | | | | | | | |
| layer | | | | | | | |
| polymer | | | | | | | |
| film (um) | | | | | | | |
| Aging | 45° C.* | 45° C.* | 45° C.* | 45° C.* | 45° C.* | 60° C.* | 60° C.* |
| condition | 48 hrs | 48 hrs | 48 hrs | 48 hrs | 48 hrs | 96 hrs | 96 hrs |
| of | → | → | → | → | → | | |
| polyolefin | 50° C. | 50° C. | 50° C. | 50° C. | 50° C. | | |
| glue | *48 hrs | *48 hrs | *48 hrs | *48 hrs | *48 hrs | | |
| Aging | 50° C.* | 50° C.* | 50° C.* | 50° C.*2 | 50° C.* | 60° C.* | 60° C.* |
| condition | 24 hrs | 24 hrs | 24 hrs | 4 hrs→ | 24 hrs | 96 hrs | 96 hrs |
| of | → | → | → | 55° C.* | → | | |
| polyurethane | 55° C.* | 55° C.* | 55° C.* | 24 hrs | 55° C.* | | |
| glue | 24 hrs | 24 hrs | 24 hrs | → | 24 hrs | | |
| | → | → | → | 60° C.* | → | | |
| | 60° C.* | 60° C.* | 60° C.* | 48 hrs | 60° C.* | | |
| | 48 hrs | 48 hrs | 48 hrs | | 48 hrs | | |
| Preheating | no | no | no | no | Preheating | no | no |
| condition | | | | | at | | |
| of outer- | | | | | 160° C. | | |
| layer | | | | | for | | |
| polymer | | | | | 20 | | |
| film | | | | | seconds | | |
| Material | nylon | nylon | nylon | nylon/ | nylon | nylon | nylon |
| of outer- | | | | PET | | | |
| layer | | | | | | | |
| polymer | | | | | | | |
| film | | | | | | | |
| Thickness | 20 | 15 | 25 | 15 | 25 | 25 | 15 |
| of | | | | | | | |
| outer- | | | | | | | |
| layer | | | | | | | |
| polymer | | | | | | | |
| film (um) | | | | | | | |
| Appearance | Δ | ◯ | Δ | ◯ | ◯ | X | X |
| after | | | | | | (warpage) | (holes |
| being | | | | | | | formed |
| punched | | | | | | | by |
| with | | | | | | | breakage) |
| a | | | | | | | |
| depth of | | | | | | | |
| 5 mm | | | | | | | |

### [Discussion Results]

Since the thickness of the outer-layer polymer film in Comparative Example 1 is too high, the stress in the outer-layer polymer film is too high, and the appearance of the aluminum plastic film exhibits apparent warpage after being punched with a depth of 5 mm. As shown in Exemplary Example 2 and Comparative Example 2, since the setting temperatures of the polyurethane glue and the polyolefin in Comparative Example 2 are not gradiently increased, the appearance of the aluminum plastic film has holes formed by breakage after being punched with a depth of 5 mm.

### Beneficial Effects of the Embodiment

In conclusion, in the aluminum plastic film and method for producing the same provided by the present disclosure, by virtue of “the ratio between the thickness of the inner-layer polymer film and the thickness of the outer-layer polymer film being between 1.6 and 5.5,” the issue with the conventional aluminum plastic film easily exhibiting warpage or holes from breakage after being applied to a battery product having a deep punching depth can be effectively improved.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A method for producing an aluminum plastic film, comprising:
a preparing process implemented by providing an aluminum foil metal film having a first surface and a second surface opposite to each other;
a polyurethane glue coating process implemented by coating a polyurethane glue onto the first surface of the aluminum foil metal film;
an outer-layer polymer film pasting process implemented by pasting an outer-layer polymer film onto the first surface through the polyurethane glue, wherein the outer-layer polymer film is at least one of a nylon polymer film, a polyester polymer film, and a multilayer nylon/polyester polymer film;
a polyolefin glue coating process implemented by coating a polyolefin glue onto the second surface of the aluminum foil metal film; and
an inner-layer polymer film pasting process implemented by pasting an inner-layer polymer film onto the second surface through the polyolefin glue to form an aluminum plastic film, wherein the inner-layer polymer film is a polyolefin polymer film, wherein a ratio between a thickness of the inner-layer polymer film and a thickness of the outer-layer polymer film is between 1.6 and 5.5.

2. The method according to claim 1, wherein, before the outer-layer polymer film pasting process, the method further includes a preheating process implemented by preheating the outer-layer polymer film at a temperature between 140° C. and 180° C. for 10 seconds to 30 seconds, wherein the thickness of the outer-layer polymer film is between 20 μm to 25 μm.

3. The method according to claim 2, wherein, after the preheating process, a machine direction shrinkage rate of the outer-layer polymer film is less than or equal to 1%, and a transverse direction shrinkage rate of the outer-layer polymer film is less than or equal to 1%.

4. The method according to claim 1, wherein the thickness of the outer-layer polymer film is between 10 μm and 20 μm.

5. The method according to claim 1, wherein, after the outer-layer polymer film pasting process, the method further includes a polyurethane glue aging process implemented by setting the aluminum foil metal film pasted with the outer-layer polymer film in an environment having a temperature between 45° C. and 65° C. for 84 hours to 108 hours.

6. The method according to claim 5, wherein the polyurethane glue aging process is divided into a first polyurethane glue aging stage, a second polyurethane glue aging stage, and a third polyurethane glue aging stage, wherein a setting time period in the third polyurethane glue aging stage is greater than a setting time period in the first polyurethane glue aging stage and a setting time period in the second polyurethane glue aging stage, wherein a setting temperature in the third polyurethane glue aging stage is greater than a setting temperature in the second polyurethane glue aging stage, and the setting temperature in the second polyurethane glue aging stage is greater than a setting temperature in the first polyurethane glue aging stage.

7. The method according to claim 1, wherein, after the inner-layer polymer film pasting process, the method further includes a polyolefin glue aging process implemented by setting the aluminum foil metal film pasted with the inner-layer polymer film in an environment having a temperature between 40° C. and 55° C. for 84 hours to 108 hours.

8. The method according to claim 7, wherein the polyolefin glue aging process is divided into a first polyolefin glue aging stage and a second polyolefin glue aging stage, wherein a setting temperature in the second polyolefin glue aging stage is greater than a setting temperature in the first polyolefin glue aging stage, and a setting time period in the second polyolefin glue aging is greater than or equal to a setting time period in the first polyolefin glue aging stage.

9. The method according to claim 1, wherein, after being punched with a punching depth of 5 mm, an appearance of the aluminum plastic film does not have warpage or holes formed by breakage.

10. An aluminum plastic film produced by implementing the method as claimed in claim 1.
